(19) United States
(12) Patent Application Publication
(10) Pub. No.: US 2013/0206823 A1
(43) Pub. Date: Aug. 15, 2013

(54) FILE

(71) Applicant: Tounichi Screen Process Co., Ltd., (US)

(72) Inventors: Takehito TAGUCHI, Kawaguchi-shi (JP); Hiroshi ORIHARA, Kasukabe-shi (JP)

(73) Assignee: Tounichi Screen Process Co., Ltd., Kawaguchi-shi (JP)

(21) Appl. No.: 13/765,735

(22) Filed: Feb. 13, 2013

(30) Foreign Application Priority Data
Feb. 14, 2012 (JP) 2012-029026

(51) Int. Cl. B42F 23/00

(52) U.S. Cl. CPC B42F 23/00
USPC 229/67.1

(57) ABSTRACT

A file including a front sheet and a back sheet that are formed by folding a sheet or overlapping two sheets, a closed portion that is a side edge portion connecting the two sheets, an opened portion formed by leaving a side edge portion opposite to the closed portion open, and a plurality of paper fixing chips and extending from the closed side edge toward the opened portion in one or both of the front sheet and the back sheet.

### BACKGROUND OF THE INVENTION

1. Field of the Invention

The present invention relates to a file configured to detachably fix a plurality of pieces of paper and that includes a paper fixing chip provided at a closed portion side that is a side where a front sheet and a back sheet for holding the pieces of paper are continuous with each other and made with the sheets.

2. Related Background Arts

Conventionally, transparent or translucent files to hold a piece of paper between a front sheet and a back sheet made from a material such as synthetic resin, paper, or the like in order to carry, organize and stock the piece of paper have been widely used. For example, a file referred to as a transparent folder, a transparent file or the like is known, which is formed by folding a broad and rectangular-shaped sheet at the center portion and overlapping thereby formed half-sized sheets to form a front sheet and a back sheet, connecting lower edge portions of the front sheet and the back sheet overlapping with each other and continuous with the folded portion by various types of connecting means such as adhesion or ultrasound to form a closed portion constituted of one side edge portion that is the folded portion and the lower edge portion, and leaving the other two edge portions that are the other side edge and the upper edge portion open so that a piece of paper can be taken in and out from the file. Further, a file that has a bag-shaped paper storage portion formed by folding back the opened portion side of one of the front sheet and the back sheet to the closed portion side and closing the lower edge portion is also known.

As described above, for a conventional file, it is necessary to close, by a proper connecting means, the lower edge portion except for the closed portion of the sheet in order to prevent the stored piece of paper from dropping off or the edge portion at the opened portion side in order to form a bag-shaped body. However, since the piece of paper held between the front and back sheets is not fixed, there is a problem that the piece of paper drops off from an edge portion at the opened portion side depending on the storage condition of the file. To prevent such a drop, there are some files in which the opened portion is provided with a lid, and by closing the lid, the piece of paper is prevented from dropping off, or files provided with a fixing means for holding the piece of paper, for example, at the closed portion or an upper edge portion of the front and back sheets.

It is necessary to separately provide a sheet with a fixing means for holding the piece of paper, separately prepare a part made from metal or synthetic resin, and fix the part as the fixing means on the sheet.

There is a file provided with a tongue that has been made by cutting a part of the front and back sheets into a predetermined width and a predetermined length from the side edge portion that is the closed portion between the front and back sheets. As described in the Japanese Patent Laid-open Application No. 2006-312294, the tongue is raised outward and is used as a tab in a drawer or a folder or used as an index portion. And thus, such a file does not include a plurality of tongues, and the tongue is not used as a means for fixing a piece of paper.

### SUMMARY OF THE INVENTION

In the above-mentioned conventional file having a structure in which a piece of paper is held between the front and back sheet, it is necessary to close at least an edge portion, or two edge portions in some cases, by a connecting means such as adhesion or ultrasound. This requires time and effort. At the same time, the held piece of paper may drop off from an opened edge portion from which the piece of paper is taken in and out.

Also, in a file having a bag-shaped body for storing a piece of paper, which is formed by folding back the edge portion at the opened portion side, it is necessary to close the lower edge portion of the bag-shaped body. Disadvantageously, this increases the usage of sheet and increases the material cost.

Further, to turn the pieces of paper held between the front and back sheets one by one, it is necessary to create a hole on the pieces of paper and separately fix the pieces of paper between the sheets with a clamp, to hold the pieces of paper with a separate clamp having a spring shape, or to store the pieces of paper, for example, after bundling the pieces of paper into a booklet shape with a locking means such as a stapler to fix the pieces of paper, or after gluing the back portions of the pieces of paper to form the pieces of paper into a book shape. Otherwise, it is necessary to pull out the pieces of paper from the file in order to turn the pieces of paper because the pieces of paper are apart one by one. Thus the file is used as a means for carrying, organizing and stocking the pieces of paper and does not have a function as a book.

Further, to fix or hold the pieces of paper between the front and back sheets, it is necessary to prepare the separate fixing means as described above and fix the fixing means on one of the front and back sheets. This causes the high cost.

To solve the above-described problems in the past, the present invention provides a file that can fix pieces of paper one by one between the front and back sheets using the front and back sheets forming the file as a paper fixing means without using a separate means such as a clamp for the fixing. Further, the file not only has a function to carry, organize, or stock the pieces of paper as storing the pieces of paper therein but also has a function as a book to turn the pieces of paper one by one to check the contents. Further, the file can get the pieces of paper apart from each other by terminating the fixing state of the file without causing defects such as a hole or a cutout portion in the pieces of paper.

The present invention is characterized by a file including: at least a front sheet and a back sheet that are formed by folding a sheet or overlapping two sheets; a closed portion that is a side edge portion formed by folding the sheet or overlapping and connecting the two sheets; an opened portion that is formed by leaving a side edge portion side opposite to the closed portion open; and a plurality of paper fixing chips each of which extends from the side edge portion of the closed portion toward the opened portion having a predetermined width and a predetermined length from a non-cut portion as a basal portion that is a part of the side edge portion of the closed portion side in one or both of the front sheet and the back sheet, and includes a peripheral portion formed to allow cutting out or detaching the paper fixing chip from the sheet, the paper fixing chips being positioned at appropriate intervals on the closed portion side, and being a means for detachably fixing a piece of paper.

Further, the present invention is characterized by the file further including: a spine between the front sheet and the back sheet, wherein the spine side is the closed portion and the paper fixing chips are formed at one or both of the front sheet or the back sheet of the closed portion.

Further, the present invention is characterized by the file, wherein the paper fixing chip is provided with a longitudinal fold line.

Further, the present invention is characterized by the file, wherein the means for detachably fixing a piece of paper as the paper fixing chip is a sticking layer that is provided on one or both of a front side and a back side of the paper fixing chip.

Further, the present invention is characterized by the file, wherein a piece of peel-off paper is attached to the front side of the sticking layer.

Further, the present invention is characterized by the file, wherein various colors other than a color of the sheet are applied to the piece of peel-off paper.

Further, the present invention is characterized by the file, wherein the means for detachably fixing a piece of paper as the paper fixing chip is a sticking layer that is provided in a small area of the paper fixing chip.

Further, the present invention is characterized by the file, wherein the means for detachably fixing a piece of paper as the paper fixing chip is a fixture that penetrates through the piece of paper.

Further, the present invention is characterized by the file, wherein the paper fixing chip is provided with a slit to form a small chip at an appropriate position and the slit and the small chip are used as paper holding means.

Further, the present invention is characterized by the file, wherein the paper fixing chip has a shape of a rectangle, a circle, an ellipse, a trapezoid, a polygon, or a combination thereof.

Further, the present invention is characterized by the file, wherein the detachable means is a perforation line and can be appropriately detached from the front sheet and the back sheet as necessary.

Further, the present invention is characterized by the file, wherein the sheet includes a transparent or translucent flexible material.

According to the file of the present invention, a part of the closed portion side of the front and back sheets is cut and used as a paper fixing chip so that the paper fixing chip can simply and detachably hold a plurality of pieces of paper one by one. Thus, the pieces of paper stored between the front and back sheets do not drop off from the file.

Further, according to the file of the present invention, the pieces of paper can be held while being fixed one by one in the file, so that the contents of the pieces of paper can be checked by turning the pieces of paper one by one, similarly to a bound booklet.

Further, according to the file of the present invention, the paper fixing chip is a sticking layer or a fixing means from which the pieces of paper can freely be detached and that does not cause defects in the pieces of paper. Thus, after being stored in the file, each of the pieces of paper is attached to and detached from the sticking layer or the fixing means. Thus, the pieces of paper can be stored by separate means as appropriate, for example, filing again or binding in or can be used for photocopy or distribution.

### BRIEF DESCRIPTION OF THE DRAWINGS

FIG. 1 is a perspective view of a file according to the present invention.

FIG. 2 is an enlarged perspective view of a paper sticking chip of the file according to the present invention.

FIG. 3 is a perspective view of another embodiment of the file according to the present invention.

FIG. 4 is an elevation view for illustrating various forms of the paper sticking chip of the file according to the present invention.

FIG. 5 is a perspective view for illustrating a state in which a piece of paper is fixed at the file according to the present invention.

FIG. 6 is a development view of another embodiment of the file according to the present invention.

FIGS. 7A and 7B are development views of another embodiment of the file according to the present invention.

### DETAILED DESCRIPTION OF PREFERRED EMBODIMENTS

Hereinafter, embodiments of the present invention will be described based on the drawings.

### Embodiment 1

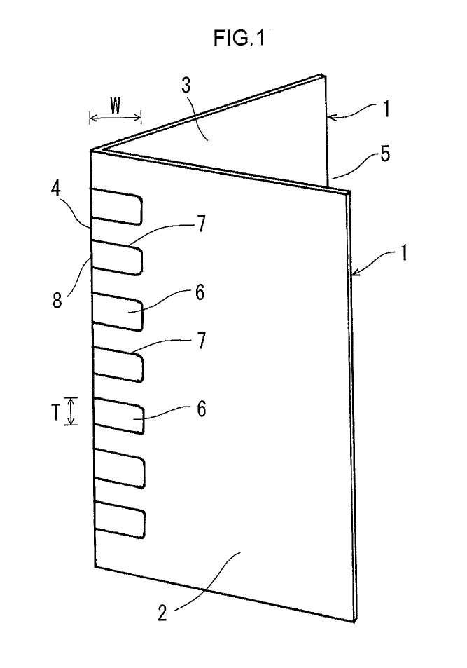

As illustrated in FIG. 1, a broad sheet 1 is folded at the center or two sheets 1 of the same size are overlapped with each other to form a front sheet 2 and a back sheet 3. A side edge portion side that is the folded side or the overlapped and contiguous side is a closed portion 4. A side edge portion side opposite to the closed portion 4 is an opened portion 5. Paper fixing chips 6 having a predetermined width T in a longitudinal direction and a predetermined length W in a lateral direction in one or both of the front sheet 2 and the back sheet 3 and extending to the opened portion 5 side are formed from the side edge portion of the closed portion 4 toward the opened portion 5.

Each of the paper fixing chips 6 includes: a non-cut portion that has the predetermined width T at the side edge portion of the closed portion 4; and a cut portion 7 that is continuously formed with upper and lower sides having the predetermined length W and extending to the opened portion 5 side in a lateral direction and with a longitudinal side connecting the front edges of the upper and lower sides. The non-cut portion at the side edge portion side of the closed portion 4 is a basal portion 8. The whole of the paper fixing chip 6 is a tongue that can freely be folded at the basal portion 8 as a base end in a direction to the surface of the front sheet 2 or the back sheet 3. A plurality of paper fixing chips 6 is formed in the longitudinal direction of the closed portion 4 side at appropriate intervals and is used as a fixing means for detachably fixing a piece of paper A.

The cut portion 7 can be cut in advance, or can also have a perforation line in such a way as to be cut from the sheet 1 as necessary. Further, the perforation line can partially be cut in such a way as to easily be cut off.

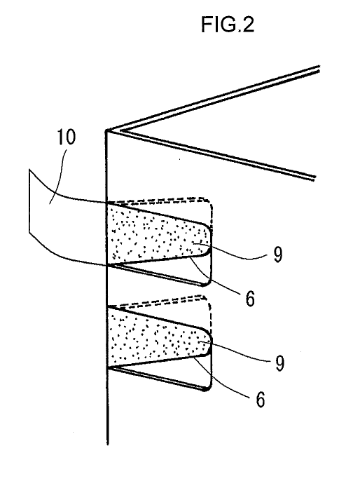

FIG. 2 illustrates an embodiment in which a sticking layer 9 is provided as the fixing means of the paper fixing chip 6. The sticking layer 9 provides an adhesion means that has a low adhesion and a small adhesive force to one or both of the front side and the back side of the paper fixing chip 6. This can detachably stick the piece of paper A. A peel-off paper 10 is stuck to the upper surface of the sticking layer 9 when the paper fixing chip 6 is unused. As many pieces of peel-off paper 10 as necessary are peeled off depending on the number of the pieces of paper A when the paper fixing chip 6 is used. A material such as Post-It (registered trademark) developed by Sumitomo 3M Limited can be used as the sticking layer that has a small adhesive force and can be freely attached to and detached from a piece of paper.

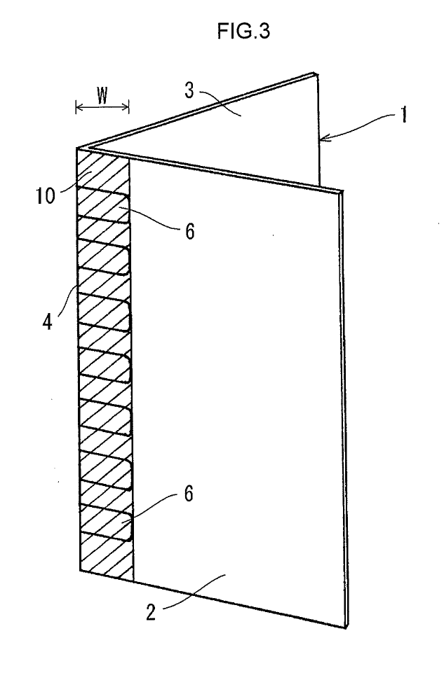

The sticking layer 9 and the piece of peel-off paper 10 can be provided at each of the paper fixing chips 6. However, for efficient production, as illustrated in FIG. 3, the sticking layer 9 is provided over the whole of an area from the top to the bottom and in the predetermined width W from the side edge portion side of the closed portion 4 to the front end side of the extension length of the paper fixing chip 6. The piece of peel-off paper 10 is stuck to the whole upper surface of the sticking layer 9. In that case, cut portions having the same shape as the paper fixing chip 6 are provided to the piece of peel-off paper 10.

By using the pieces of peel-off paper 10 having various colors, the types of the pieces of paper A stored in the file can be differentiated. The paper fixing chips 6 can be used by removing the piece of peel-off papers 10 on the paper fixing chips 6 that have separately been formed at appropriate portions in advance depending on a fixed number of the pieces of paper A or that have been cut along the perforation line around the paper fixing chips 6 in a state connected by the perforation line. Thus, a colored piece of peel-off paper 10 remains on the unused paper fixing chip 6 and at the part between the paper fixing chips 6 without being peeled off.

The sticking layer 9 of the paper fixing chip 6 can be provided in spots as well as over the whole of one or both of the front side and the back side of the paper fixing chip 6. Even if the sticking layer has a comparatively strong adhesive force, the piece of paper A can easily be removed and is hardly damaged when the sticking layer is provided in spots. In that case, the piece of peel-off paper 10 can be provided only on the sticking layer 9 having a small area. Alternatively, without providing such a piece of peel-off paper 10, a pressure-sensitive adhesive or the like exerting the adhesive function by an external stimulation such as a pressure or heat can be provided.

Further, a mechanical fastening means such as stapling with a stapler can be used as the fixing means to overlap and fix the paper fixing chip 6 and the piece of paper A. For example, when the piece of paper A is stapled with a stapler, a pinhole is made in the piece of paper A. However, this does not cause damages in the piece of paper and does not affect the reuse of the piece of paper A.

If the paper fixing chip 6 has a long extension length, for example, making the paper fixing chip 6 transparent or translucent can prevent a word, a diagram or the like on the piece of paper A from being hidden. In such a case, the whole of the sheet 1 is made transparent or translucent.

Further, by making the front sheet 2 transparent or translucent, a piece of paper A including a title thereon can be used as a first piece of paper A positioned at the back side of the front sheet 2 so that the title is visible from the outside. This can omit the requirement to provide a headline such as a title on the front sheet 2 in the file that has a thin sheet shape and does not have a spine, and the title can be checked from the outside with the piece of paper A inside.

Further, by using paper, a thin sheet made from a piece of paper coated with a synthetic resin material, or a flexible material including polypropylene, polyester, polyethylene, acrylic, or the like as the material of the file, the turn of the front sheet 2 and the back sheet 3 by hand can be facilitated.

The sticking layer 9 can be provided only on one side of the paper fixing chip 6, or also on both sides of the paper fixing chip 6 as necessary, so that more pieces of paper A can be held. Especially, when only one side of the piece of paper A is printed and the back side is unprinted, the paper fixing chip 6 having sticking layers on both sides can more efficiently store the pieces of paper.

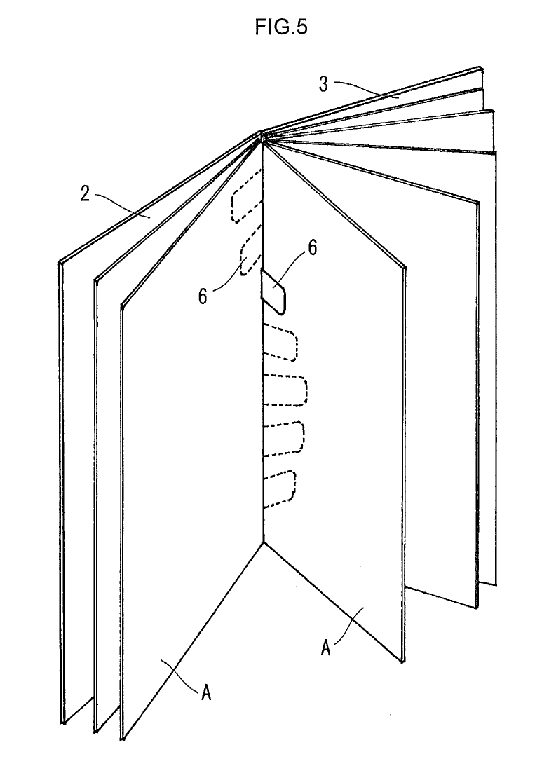

FIG. 5 is a perspective view illustrating a state in which the pieces of paper A are detachably fixed one by one at the paper fixing chips 6 of the file of the present invention. In FIG. 5, the pieces of paper A are sequentially fixed at the paper fixing chips 6 from top to bottom. The sequence of fixing can freely be changed as appropriate.

### Embodiment 2

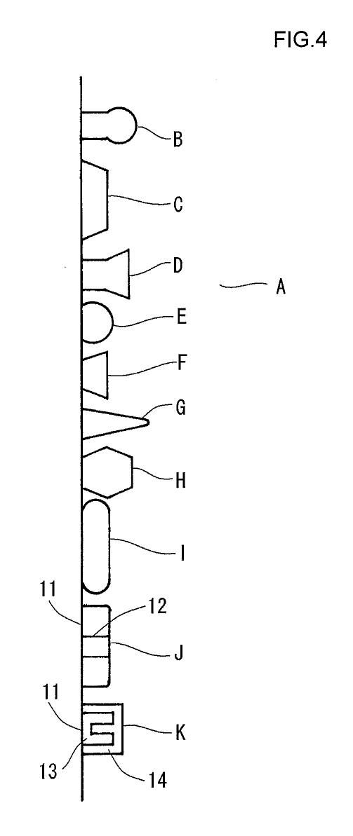

As illustrated in FIG. 4, B to I, the paper fixing chip 6 can have various shapes such as a rectangle, a circle, an ellipse, a trapezoid, a polygon, or a combination thereof. The paper fixing chip 6 with various shapes can be adopted, for example, a shape having a long width and a short extension length, or a shape having a narrow width and a long extension length as long as the paper fixing chip 6 has a predetermined width T and a predetermined length W to hold the piece of paper A and has a certain sticking area not to cause a predetermined pieces of paper A to drop off.

### Embodiment 3

J and K illustrated in FIG. 4 are other embodiments of a paper fixing chip 11. A paper locking means is provided instead of the sticking layer of the above-mentioned embodiments 1 and 2. J illustrated in FIG. 4 is the paper fixing chip 11 that has a long longitudinal length or also has a long lateral extension length and that is provided with a slit 12 in the lateral direction. By providing a given number of slits 12, some small chips are formed, and the adjacent small chips are alternately positioned on the front side and the back side of the piece of paper A in such a way as to put the piece of paper A between the slits 12 to fix the piece of paper A.

Further, K illustrated in FIG. 4 is the paper fixing chip 11 that has a long longitudinal length or also has a long lateral extension length. In the paper fixing chip, an internal fixing chip 13 and an external fixing chip 14 are formed by cutting them respectively in such a manner that pressure chips having concave and convex shapes, for example, are formed at the protruding front edge side to put the piece of paper A between the pressure chips and fix the piece of paper A. In addition to effects similar to the effect of the above-mentioned embodiments 1 and 2, a paper fixing means can be obtained only by a process of cutting the sheet.

### Embodiment 4

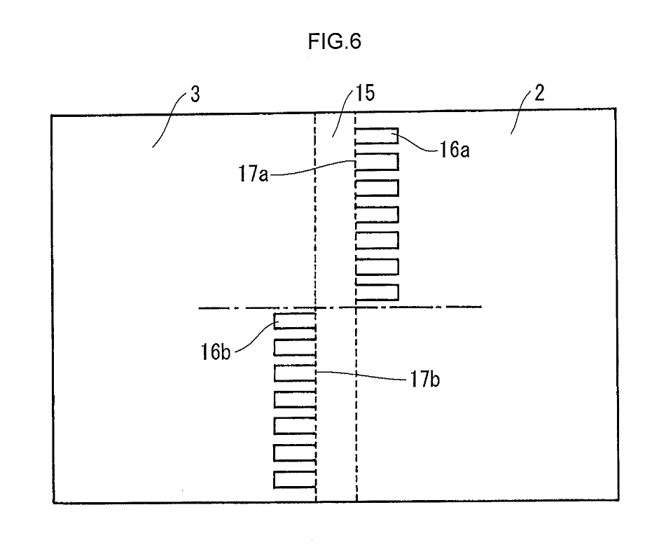

FIG. 6 is an embodiment that is provided with a spine 15 between the front sheet 2 and the back sheet 3. In that case, a paper fixing chip 16a of the front sheet 2 and a paper fixing chip 16b of the back sheet 3 are divided at the longitudinal center of the spine 15 and are arranged. Each of the paper fixing chips 16a and 16b is a tongue that is provided with each of basal portions 17a and 17b to be a non-cut portion at each of the right and left side edge portions of the spine 15 side to be a closed portion, and that is freely folded at each of the basal portions 17a and 17b as the base end of each of the paper fixing chips 16a and 16b in a direction of the surface of the front sheet 2 or the back sheet 3. The piece of paper A can fixedly be held from both of the front sheet 2 side and the back sheet 3 side. The piece of paper A can evenly or nearly evenly be fixed according to the width of the spine 15.

Providing the spine 15 can hold more pieces of paper A. Means, shapes and the like similar to those in the above-mentioned embodiments can be adopted to the fixing means of the piece of paper A, the shapes of the paper fixing chips 16a and 16b, and the like.

### Embodiment 5

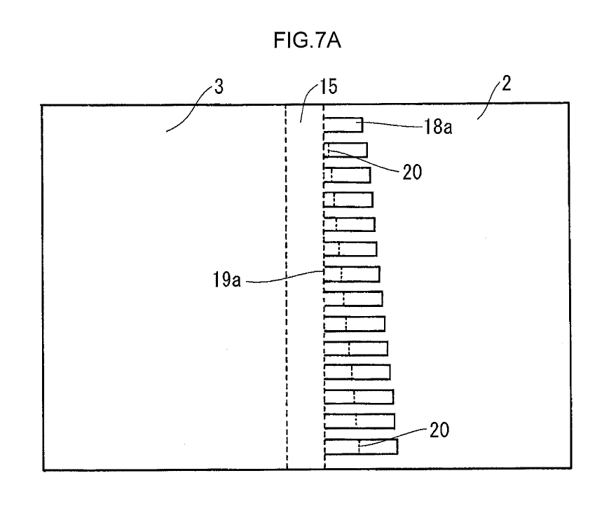

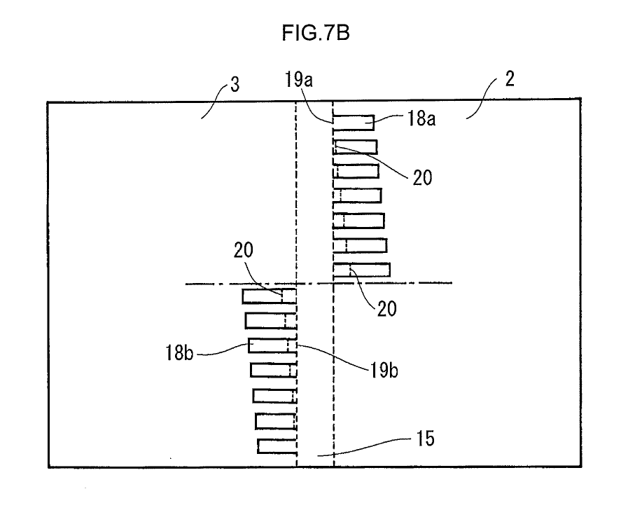

FIGS. 7A and 7B are embodiments that are provided with the spine 15 between the front sheet 2 and the back sheet 3, similarly to the above embodiment. In that case, a paper fixing chips 18a and 18b are arranged only at one of the front sheet 2 and the back sheet 3 or are divided and arranged at both of the front sheet 2 and the back sheet 3. Each of the paper fixing chips 18a and 18b is a tongue that is provided with each of basal portions 19a and 19b to be a non-cut portion at each of the right and left side edge portions of the spine 15, and that is freely folded at each of the basal portions 19a and 19b as a base end in a direction of the surface of the front sheet 2 or the back sheet 3.

As illustrated in FIG. 7A, the paper fixing chip 18a is provided only at the front sheet 2 side, and is provided with a longitudinal fold line 20. The fold lines 20 are provided at positions gradually away from the side edge portion side as the basal portion 19a and closer to the opened portion side from the top to the bottom of the spine 15, and the bottom fold line 20 is positioned approximately at a distance of the width of the spine 15 away from the basal portion. Thus, the pieces of paper A can be fixed between the front sheet 2 and the back sheet 3 by various fixing means while being evenly arranged.

As illustrated in FIG. 7B, the paper fixing chips 18a and 18b are divided into a front sheet 2 side and a back sheet 3 side at the longitudinal center of the spine 15 and are arranged. The fold lines 20 in the front sheet 2 are provided at positions gradually away from the side edge portion side as the basal portion 19a and closer to the opened portion side from the top to the bottom of the spine 15 in such a way as to be, and the bottom fold line 20 is positioned at the center and approximately at a distance of half the width of the spine 15 away from the basal portion. In the back sheet 3, positions of the fold lines 20 are started approximately at a distance of half the width of the spine 15 away from the basal portion at the top and finished at the basal portion 19b at the bottom.

The fold line 20 can be a perforation line, a drawn line, or the like as appropriate in such away as to easily be folded. Further, means, shapes and the like similar to those in the above-mentioned embodiments can be adopted to the means for fixing the piece of paper A to the paper fixing chips 16a, 16b, 18a, and 18b, the shapes of the paper fixing chips 16a, 16b, 18a, and 18b, and the like. Further, appropriately combining the embodiments 1 to 5 can give another embodiment.

What is claimed is:

1. A file comprising:
at least a front sheet and a back sheet that are formed by folding a sheet or overlapping two sheets;
a closed portion that is a side edge portion formed by folding the sheet or overlapping and connecting the two sheets;
an opened portion that is formed by leaving a side edge portion side opposite to the closed portion open; and
a plurality of paper fixing chips each of which extends from the side edge portion of the closed portion toward the opened portion having a predetermined width and a predetermined length from a non-cut portion as a basal portion that is a part of the side edge portion of the closed portion side in one or both of the front sheet and the back sheet, and includes a peripheral portion formed to allow cutting out or detaching the paper fixing chip from the sheet, the paper fixing chips being positioned at appropriate intervals on the closed portion side, and being a means for detachably fixing a piece of paper.

2. The file according to claim 1, further comprising:
a spine between the front sheet and the back sheet,
wherein the spine side is the closed portion, and the paper fixing chips are formed at one or both of the front sheet and the back sheet of the closed portion.

3. The file according to claim 1,
wherein the paper fixing chip is provided with a longitudinal fold line.

4. The file according to claim 1,
wherein the means for detachably fixing a piece of paper as the paper fixing chip is a sticking layer that is provided on one or both of a front side and a back side of the paper fixing chip.

5. The file according to claim 1,
wherein a piece of peel-off paper is attached to the sticking layer that is provided at one or both of a front side and a back side of the paper fixing chip as the means for detachably fixing a piece of paper as the paper fixing chip.

6. The file according to claim 1,
wherein various colors other than a color of the sheet are applied to the piece of peel-off paper that is attached to the sticking layer that is provided at one or both of a front side and a back side of the paper fixing chip as the means for detachably fixing a piece of paper as the paper fixing chip.

7. The file according to claim 1,
wherein the means for detachably fixing a piece of paper as the paper fixing chip is a sticking layer that is provided in a small area of the paper fixing chip.

8. The file according to claim 1,
wherein the means for detachably fixing a piece of paper as the paper fixing chip is a fixture that penetrates through the piece of paper.

9. The file according to claim 1,
wherein the paper fixing chip is provided with a slit to form a small chip at an appropriate position, and the slit and the small chip is used as a paper holding means.

10. The file according to claim 1,
wherein the paper fixing chip has a shape of a rectangle, a circle, an ellipse, a trapezoid, a polygon, or a combination thereof.

11. The file according to claim 1,
wherein a detachable means is a perforation line and can be appropriately detached from the front sheet and the back sheet as necessary.

12. The file according to claim 1,
wherein the sheet includes a transparent or translucent and flexible material.
